(19) United States
(12) Patent Application Publication
(10) Pub. No.: US 2017/0230256 A1
(43) Pub. Date: Aug. 10, 2017

(54) SYSTEM AND METHOD FOR ASSESSING THE ACCURACY OF IP ADDRESS-BASED GEOLOCATION DATA

(71) Applicant: Google Inc., Mountain View, CA (US)

(72) Inventors: Shlomo Reuben Urbach, Rehovot (IL); Gil Ran, Tel-Aviv (IL)

(21) Appl. No.: 14/461,540

(22) Filed: Aug. 18, 2014

(51) Int. Cl. H04L 12/24; H04L 12/26

(52) U.S. Cl. CPC H04L 41/50; H04L 43/0876

(57) ABSTRACT

In one aspect, a computer-implemented method for assessing the accuracy of Internet Protocol (IP) address-based geolocation data may generally include accessing a first set of usage pattern data associated with a plurality of IP addresses that are known to be assigned to computing devices located within a geographic area, wherein the first set of usage pattern data is associated with online-based activities. The method may also include determining a usage pattern classifier for the geographic area based on the first set of usage pattern data and accessing a second set of usage pattern data associated with at least one IP address contained within an IP block that has been mapped to the geographic area, wherein the second set of usage pattern data is associated with online-based activities. In addition, the method may include analyzing the second set of usage pattern data based on the usage pattern classifier.

### FIELD

The present subject matter relates generally to geolocation using Internal Protocol (IP) addresses and, more particularly, to a system and method for assessing the accuracy of IP address-based geolocation data.

### BACKGROUND

IP address-based geolocation generally refers to the practice of estimating or inferring the geographic location of a computing device based on the IP address assigned to such device. Currently, various data collections exists that map IP addresses to specific geographic locations. Such data collections typically rely on mapping the wide range of IP addresses (in the form of an IP block) associated with a proxy server or internet service provider to the known location of such server/provider. However, given that the data collections are constantly changing and the inherent assumptions that must be made in correlating IP addresses to proxy/provider locations, IP address-based geolocation data may often contain errors.

### SUMMARY

Aspects and advantages of embodiments of the invention will be set forth in part in the following description, or may be obvious from the description, or may be learned through practice of the embodiments.

In one aspect, the present subject matter is directed to a computer-implemented method for assessing the accuracy of Internet Protocol (IP) address-based geolocation data. The method may generally include accessing a first set of usage pattern data associated with a plurality of IP addresses that are known to be assigned to computing devices located within a geographic area, wherein the first set of usage pattern data is associated with online-based activities. The method may also include determining a usage pattern classifier for the geographic area based on the first set of usage pattern data and accessing a second set of usage pattern data associated with at least one IP address contained within an IP block that has been mapped to the geographic area, wherein the second set of usage pattern data is associated with online-based activities. In addition, the method may include analyzing the second set of usage pattern data based on the usage pattern classifier in order to assess the accuracy of the mapping of the IP block to the geographic area.

In another aspect, the present subject matter is directed to a system for assessing the accuracy of Internet Protocol (IP) address-based geolocation data. The system may generally include one or more computing devices including one or more processors and associated memory. The memory may store instructions that, when executed by the processor(s), configure the computing device(s) to access a first set of usage pattern data associated with a plurality of IP addresses associated within a geographic area, wherein the first set of usage pattern data is associated with online-based activities. The computing device(s) may also be configured to determine a usage pattern classifier for the geographic area based on the first set of usage pattern data and access a second set of usage pattern data associated with at least one IP address that has been mapped to the geographic area, wherein the second set of usage pattern data is associated with online-based activities. In addition, the computing device(s) may be configured to analyze the second set of usage pattern data based on the usage pattern classifier in order to assess the accuracy of the mapping of the IP address(es) to the geographic area.

In a further aspect, the present subject matter is directed to a tangible, non-transitory computer-readable medium storing computer-executable instructions that, when executed by one or more processors, cause the processor(s) to perform specific operations. The operations may generally include accessing a usage pattern classifier for each of a plurality of different geographic areas, wherein each usage pattern classifier is based on usage pattern data derived from a plurality of IP addresses that are known to be assigned to computing devices located within one of the geographic areas. The operations may also include accessing a second set of usage pattern data associated with at least one IP address contained within an IP block, inputting the second set of usage pattern data into the usage pattern classifier for each geographic area to generate a confidence score associated with the geographic area and identifying at least one candidate geographic area out of the plurality of different geographic areas for mapping the IP block based on the confidence score.

Other exemplary aspects of the present disclosure are directed to other methods, systems, apparatus, non-transitory computer-readable media, user interfaces and devices for assessing the accuracy of IP address-based geolocation data.

These and other features, aspects and advantages of the various embodiments will become better understood with reference to the following description and appended claims. The accompanying drawings which are incorporated in and constitute a part of this specification, illustrate embodiments of the invention and, together with the description, serve to explain the related principles.

### BRIEF DESCRIPTION OF THE DRAWINGS

Detailed discussion of embodiments directed to one of ordinary skill in the art, are set forth in the specification, which makes reference to the appended figures, in which:

FIG. 1 illustrates a schematic diagram of one embodiment of a system for assessing the accuracy of IP address-based geolocation data in accordance with aspects of the present subject matter; and

FIG. 2 illustrates a flow diagram of one embodiment of a method for assessing the accuracy of IP address-based geolocation data in accordance with aspects of the present subject matter.

### DETAILED DESCRIPTION

Reference now will be made in detail to embodiments, one or more examples of which are illustrated in the drawings. Each example is provided by way of explanation of the embodiments, not limitation. In fact, it will be apparent to those skilled in the art that various modifications and variations can be made to the embodiments without departing from the scope or spirit of the embodiments. For instance, features illustrated or described as part of one embodiment can be used with another embodiment to yield a still further embodiment. Thus, it is intended that the present subject matter cover such modifications and variations as come within the scope of the appended claims and their equivalents.

In general, the present subject matter is directed to computer-implemented methods and related systems for accessing the accuracy of IP address-based geolocation data. Specifically, as indicated above, various data collections exist that map IP addresses to specific geographic locations. However, given the current methodologies used to provide such mappings, IP address-based geolocation data may often contain errors. As will be described below, the present disclosure may be utilized to determine whether a given set of IP addresses has been accurately mapped to a particular geographic area.

To assess the accuracy of IP address-based geolocation data, the disclosed methodology, in several embodiments, utilizes online-based usage pattern data to flag IP blocks that may be incorrectly mapped to a given geographic area (e.g., a country, state or any other geographic region or entity). In particular, usage pattern data may be initially collected based on the online activities of users located within each relevant geographic area. For instance, to assess IP blocks on a country-by-country basis, usage pattern data may be collected based on the online activities of users located within each country. The usage pattern data may then be fed into a machine-learning system or algorithm in order to develop a usage pattern classifier for each country. Thereafter, similar usage pattern data may be collected for each IP block that has been mapped to a specific country. Such usage pattern data may then be input into the usage pattern classifier developed for the country associated with the IP block to identify a confidence score that indicates how well the data matches the initially collected usage pattern data for that country. If the confidence score falls below a predetermined threshold, the IP block may be flagged as containing some level of inaccuracies. The flagged IP block may then be subsequently analyzed using any suitable methodology to identify/correct the inaccuracies. In addition, a list of countries may be identified that more accurately match the IP-block's data by running the data through the usage pattern classifiers of other countries and determining the highest associated confidence score.

In general, the usage pattern data may derive from any suitable online-based pattern signals. For instance, suitable pattern signals may include, but are not limited to, usage cycles of online-based applications (e.g., Google Search, Gmail and/or any other suitable online-based applications provided by Google, Inc.), the distribution of languages used in online searching, the distribution of online transactions, the daily search volume for specific time-associated search terms (e.g., breakfast, lunch, etc.), weekly vs. weekend online usage patterns, etc. Thus, for example, if the language distribution of online searching by users in France is typically 70% French, 10% English, 10% German and 10% other languages, usage pattern data for an IP block mapped to France that indicates that 50% of the online searches are conducted in a language other than French may indicate that the IP block is improperly mapped to France.

Additionally, in several embodiments, the usage pattern data may be utilized to identify candidate geographic areas for mapping an IP block that has not been previously assigned or otherwise mapped to a given geographic area. For example, by using usage pattern data collected for a plurality of different geographic areas to develop a usage pattern classifier for each geographic area, the usage pattern data collected for a previously unassigned IP block may be input into each usage pattern classifier in order to identify one or more candidate geographic areas to which the IP block may potentially be mapped. In doing so, the IP block may, for example, be automatically mapped to the geographic area resulting in the highest confidence score. Alternatively, the geographic areas associated with the highest confidence scores (e.g., the top five scores or scores above a given threshold) may be identified as potential mapping candidates and flagged for subsequent analysis to determine which geographic area the IP block should be mapped.

It should be appreciated that the technology described herein makes reference to computing devices, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer processes discussed herein may be implemented using a single computing device or multiple computing devices working in combination. Databases and applications may be implemented on a single system or distributed across multiple systems. Distributed components may operate sequentially or in parallel.

It should also be appreciated that, in situations in which the systems and methods described herein access and analyze personal information about users, make use of personal information and/or access and analyze online-based activities of users, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user. Accordingly, in several embodiments of the present subject matter, in order to obtain the benefits of the techniques described herein, a user may be required to install an application and/or select a setting to provide consent for the collection and/or analysis of usage pattern data associated with the online-based activities of the user. If the user does not provide such consent, the benefits of the techniques described herein may not be received.

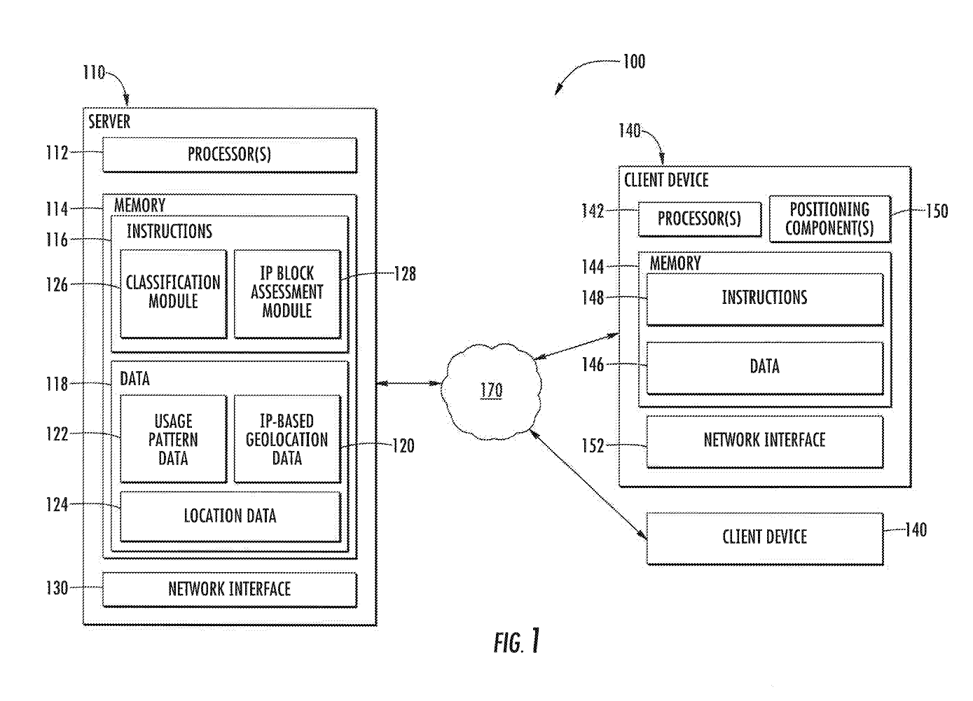

Referring now to FIG. 1, one embodiment of a system 100 for assessing the accuracy of IP address-based geolocation data is illustrated in accordance with aspects of the present subject matter. As shown in FIG. 1, the system 100 may include a client-server architecture where a server 110 communicates with one or more clients, such as a local client device 140, over a network 170. The server 110 may generally be any suitable computing device, such as a remote web server(s) or a local server(s), and/or any suitable combination of computing devices. For instance, the server 110 may be implemented as a parallel or distributed system in which two or more computing devices act together as a single server. Similarly, the client device 140 may generally be any suitable computing device(s), such as a laptop(s), desktop(s), smartphone(s), tablet(s), wearable computing device(s), a display with one or more processors coupled thereto and/or embedded therein and/or any other computing device(s). Although only two client devices 140 are shown in FIG. 1, it should be appreciated that any number of clients may be connected to the server 110 over the network 170.

As shown in FIG. 1, the server 110 may include a processor(s) 112 and a memory 114. The processor(s) 112 may be any suitable processing device, such as a microprocessor, microcontroller, integrated circuit, or other suitable processing device. Similarly, the memory 114 may include any suitable computer-readable medium or media, including, but not limited to, non-transitory computer-readable media, RAM, ROM, hard drives, flash drives, or other memory devices. The memory 114 may store information accessible by processor(s) 112, including instructions 116 that can be executed by processor(s) 112 and data 118 that can be retrieved, manipulated, created, or stored by processor(s) 112. In several embodiments, the data 118 may be stored in one or more databases.

For instance, as shown in FIG. 1, the memory 114 may include a geolocation database 120 for storing geolocation data. Specifically, in several embodiments, the geolocation data may correspond to IP address-based geolocation data and, thus, may include a mapping of IP addresses to given geographic locations and/or areas. For example, the geolocation data may include a plurality of IP blocks, with each IP block corresponding to a specific range of IP addresses. In such an embodiment, each IP block may be mapped to a given geographic area, such as a country, state, province, city and/or any other suitable geographic entity encompassing a given area.

As will be described below, the present disclosure may be utilized to assess the accuracy of IP address-based geolocation data. Thus, in several embodiments, the geolocation data stored within the geolocation database 120 may be accessed and analyzed to determine its accuracy. Alternatively, the present subject matter may be utilized to assess the accuracy of any other suitable IP address-based geolocation data, such as geolocation data stored within any other database accessible to the server 110, including remote databases that must be accessed via the network 170.

In several embodiments, the memory 114 may also include a usage pattern database 122 storing data associated with the online usage patterns of users. Specifically, the usage pattern data may generally correspond to data collected from client devices 140 that is associated with the online-based activities of the users of such devices 140. Thus, it should be appreciated that the usage pattern data may generally derive from any suitable online-based pattern signal(s). For instance, as will be described in greater detail below, suitable online-based pattern signals may include, but are not limited to, usage cycles of online-based applications, the distribution of languages used in online text entry, the distribution of online transactions, the usage of specific time-related search terms and/or various other online-based usage patterns (e.g., weekly vs. weekend online usage patterns). Data associated with such pattern signals may be collected from client devices 140 and stored within the database 122 for subsequent analysis.

It should be appreciated that the usage pattern data may be collected by the server 110, itself, or by any other suitable computing device/server, such as the servers associated with various online services. In addition, it should be appreciated that the usage pattern data need not be stored locally at the server 110 (e.g., within database 122). For instance, in alternative embodiments, the usage pattern data may be stored within any other suitable database that is accessible to the server 110, including remote databases that must be accessed via the network 170.

In several embodiments, the usage pattern data may be collected and grouped based on the geographic area from which the data was known to be collected (or assumed to be collected). For example, as will be described below, an initial set of usage pattern data may be collected and stored that derives from IP addresses that are known to be assigned to client devices 140 located within a specific geographic area. Such data may then, for instance, be used to train an associated classifier for the geographic area. In addition, a second set of usage pattern data may be collected and stored that derives from client devices 140 associated with IP addresses included within an IP block that had been previously mapped to the geographic area. The usage pattern data associated with the IP block may then be analyzed using the classifier to assess the accuracy of the IP block's mapping to the specific geographic area.

It should be appreciated that the server's memory 114 may also include any other suitable database(s) storing any other suitable type of data. For example, as shown in FIG. 1, the memory 114 may include a location database 124 storing data that may provide a further indication of the geographic area within which a client device 140 is located (e.g., an indication of a device's location beyond that provided by the IP address associated with such device 140). For instance, the database 124 may include position data received from a positioning component(s) 150 of each client device 140 that relates to the current geographic location of the device 140. In addition to such position data, or as an alternative thereto, the database 124 may include user-specific data that provides an indication of the geographic area within which a client device 140 is located. For example, users may provide location information (e.g., their home address) when using certain online applications. Such information may be collected and used to infer the geographic area within which the user's device 140 is located.

Referring still to FIG. 1, the instructions 116 stored within the memory 114 may he executed by the processor(s) 112 to implement a classification module 126. In several embodiments, the classification module 126 may be configured to analyze the usage pattern data stored within the usage pattern database 122 and develop a classifier that characterizes the online usage patterns of users located within a given geographic area. In doing so, the classification module 126 may be configured to develop a specific or unique classifier for each geographic area across which the geolocation data is being analyzed. For example, if the geolocation data is being analyzed on a country-by-country basis, the classification module 126 may be configured to develop a specific classifier for each country for which at least one IP block or address has been mapped thereto. Similarly, if the geolocation data is being analyzed on a state-by-state or a city-by-city basis, the classification module 126 may be configured to develop a specific classifier for each state/city that has at least one IP block mapped thereto.

To develop a unique classifier for a particular geographic area, the classification module 126 may, in several embodiments, only be configured to analyze the usage pattern data deriving from IP addresses that are known to be assigned to client devices 140 located within the geographic area. For example, as indicated above, various types of location data may be collected by and/or accessible to the server 110 (e.g., within database 124) that provide an indication of the geographic location of a given client device 140. For instance, position data collected from a positioning component(s) 150 of a client device 140 may be used to confirm that the device 140 is located within a specific geographic area at the time at which the usage pattern data was collected. Similarly, for online-based applications implemented on a client device 140 for which a user has provided his/her home addresses, it may be inferred that the user is located at such address when the user has signed into the application using his/her device 140.

In several embodiments, the classification module 126 may be configured to develop each usage pattern classifier by implementing a suitable machine learning system or algorithm. Specifically, the usage pattern data deriving from IP addresses that are known to be assigned to client devices 140 located within a given geographic area may be input as training data into the machine learning algorithm in order to generate a classifier that provides a characterization of the online-based activities of users located within the geographic area. In such embodiments, the machine learning algorithm may generally correspond to any suitable classification algorithm, such as a neural network learning algorithms(s), a naive Bayes classifier algorithm(s) and/or the like.

Additionally, as shown in FIG. 1, the instructions 116 stored within the memory 114 may also be executed by the processor(s) 112 to implement an IP block assessment module 128. In several embodiments, the IP block assessment module 128 may e configured to analyze the usage pattern data derived from client devices 140 associated with IP addresses included within an IP block that has been previously mapped to a given geographic area based on the usage pattern classifier developed for such geographic area. Specifically, as indicated above, a unique classifier may be developed for a specific geographic area (e.g., using the classification module 126) that is based on the usage pattern data derived from IP addresses known to be assigned to client devices 140 located within the geographic area. Thereafter, for each IP block mapped to the geographic area, the IP block assessment module 128 may be configured to utilize the classifier to assess the usage pattern data derived from IP addresses contained within the IP block. For example, by inputting the IP block's usage pattern data into the classifier, a confidence score may be assigned to the IP block that is indicative of how well the data matches the usage pattern data used to develop the classifier. Since the usage pattern data used to develop the classifier was known to derive from client devices 140 located within the geographic area, the confidence score may directly relate to the accuracy of the mapping of the IP block to such geographic area. If the confidence score is high, it may be determined that the IP block was properly mapped to the geographic area. However, if the confidence score is low (e.g., below a predetermined threshold), the mapping of the IP block may be identified as being inaccurate or may simply be flagged as needing further analysis to assess its accuracy.

Additionally, the IP block assessment module 128 may also be configured to identify a candidate geographic area(s) for an IP block that has not yet been mapped or otherwise assigned to a given geographic area. Specifically, by inputting the IP block's usage pattern data into each classifier that has been developed for the various geographic areas, the IP block assessment module 128 may determine which geographic area(s) is associated with usage pattern data that most closely matches the IP block's data. For example, the IP block assessment module 128 may determine a confidence score for each geographic area based on the analysis of the IP block's usage pattern data within the area's corresponding classifier. Thereafter, the IP block assessment module 128 may identify the geographic area associated with the highest confidence score as the best candidate for mapping the IP block. Alternatively, the IP block assessment module 128 may simply be configured to identify the geographic area(s) having confidence scores above a given threshold. In such instance, the identified geographic area(s) may then be flagged for subsequent analysis to determine which area(s) the IP block should be mapped.

It should be appreciated that, as used herein, the term “module” refers to computer logic utilized to provide desired functionality. Thus, a module may be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, ROM, hard disk or optical or magnetic media.

As shown in FIG. 1, the server 110 may also include a network interface 130 for providing communications over the network 170. In general, the network interface 130 may be any device/medium that allows the server 110 to interface with the network 170.

Similar to the server 110, the client device 140 may also include one or more processors 142 and associated memory 144. The processor(s) 142 may be any suitable processing device known in the art, such as a microprocessor, microcontroller, integrated circuit, or other suitable processing device. Similarly, the memory 144 may be any suitable computer-readable medium or media, including, but not limited to, non-transitory computer-readable media, RAM, ROM, hard drives, flash drives, or other memory devices. As is generally understood, the memory 144 may be configured to store various types of information, such as data 146 that may be accessed by the processor(s) 142 and instructions 148 that may be executed by the processor(s) 142. The data 146 may generally correspond to any suitable files or other data that may be retrieved, manipulated, created, or stored by processor(s) 142. In several embodiments, the data 146 may be stored in one or more databases. Similarly, the instructions 148 stored within the memory 144 may generally be any set of instructions that, when executed by the processor(s) 142, cause the processor(s) 142 to provide desired functionality. For example, the instructions 148 may be software instructions rendered in a computer readable form or the instructions may be implemented using hard-wired logic or other circuitry.

In addition, the client device 140 may also include a positioning component(s) 150 for generating position data associated with the current geographic location of the device 140. For instance, the positioning component(s) 150 may be a UPS module or sensor configured to determine position data for the client device 140 based on signals received from one or more satellites. In another embodiment, the positioning component(s) 150 may be a location module or sensor configured to determine position data for the client device 140 based on signals received from one or more cell phone towers. Alternatively, the positioning component(s) 150 may be any other suitable module, sensor and/or component that is capable of determining position data for the client device 140. The position data may include, for example, time-stamped geographic coordinates for the client device 140, which may, in turn, allow the travel velocity of the client device 140 to be determined. As indicated above, the client device 140 may be configured to communicate the position data to the server 110 over the network 170.

Moreover, as shown in FIG. 1, the client device 140 may also include a network interface 152 for providing communications over the network 170. Similar to the interface 130 for the server 110, the network interface 152 may generally be any device/medium that allows the client device 140 to interface with the network 170.

It should be appreciated that the network 170 may be any type of communications network, such as a local area network (e.g. intranet), wide area network (e.g. Internet), or some combination thereof. The network can also include a direct connection between the client device 140 and the server 110. In general, communication between the server 110 and the client device 140 may be carried via a network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

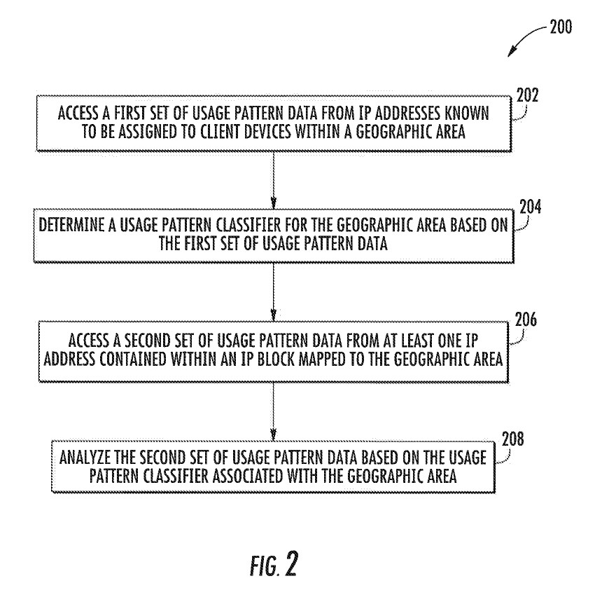

Referring now to FIG. 2, a flow diagram of one embodiment of a method 200 for assessing the accuracy of IP address-based geolocation data is illustrated in accordance with aspects of the present subject matter. The method 200 will generally be discussed herein with reference to the system 100 shown in FIG. 1. However, those of ordinary skill in the art, using the disclosures provided herein, should appreciate that the methods described herein may be executed by any computing device or any combination of computing devices. Additionally, it should be appreciated that, although the method blocks 202-208 are shown in FIG. 2 in a specific order, the various blocks of the disclosed method 200 may generally be performed in any suitable order that is consistent with the disclosure provided herein.

As shown, at (202), the method 200 includes accessing a first set of usage pattern data from IP addresses known to be assigned to client devices 140 located within a given geographic area. Specifically, as indicated above, for each geographic area having an IP block or address mapped thereto, the server 110 may be configured to collect and/or access an initial set of usage pattern data that is associated with the online based activities of users located in such geographic area. As will be described below, this initial set of usage pattern data may then be used as training data to develop a usage pattern classifier for the geographic area.

As indicated above, the usage pattern data available to the server 110 may generally derive from any suitable online-based pattern signal(s). However, in several embodiments, the pattern signal(s) utilized for the collection of the usage pattern data may be selected based on the likelihood of variations existing between individual geographic areas, thereby providing a strong signal for differentiating the usage patterns within the various geographic areas being classified. For example, in one embodiment, the usage pattern data may derive, at least in part, from data associated with the usage cycles of online-based applications. Specifically, such usage cycles may indicate that users within a geographic area are more likely to access or use certain online-based applications (e.g., online email applications, online searching applications, social media applications) at certain times in the day and/or on certain days of the week (e.g., weekdays vs. weekends). By collecting data associated with the usage cycles, the data may provide a means of differentiating between the online usage patterns of users within different geographic areas. For example, if the usage cycles for a given social media application indicate that users in Spain are more likely to access the application in the morning during weekdays while users in Portugal are more likely to access the application at night during weekdays, subsequent usage pattern data collected from certain IP addresses that indicates high usage of the application on a Thursday night may provide a stronger indication that the client devices 140 associated with such IP addresses are located in Portugal instead of Spain. Similarly, if the usage cycles for a given email application indicate that users in the United States, Germany and Australia are more likely to access the application on Saturday between the hours of 9:00 AM and 11:00 AM, the time differential existing between such geographic areas may allow for the differentiation between users located in the United States, Germany and Australia.

Additionally, in one embodiment, the usage pattern data may derive, at least in part, from data associated with the distribution of languages used in online text entry, such as the specific language used in online search entries. Specifically, the distribution of languages used in the online text entry may provide a strong signal for differentiating between geographic areas in which the primary language spoken differs, particularly for adjacent geographic areas. For example, for an area(s) adjacent to the border between the United States and Mexico, the primary usage of English or Spanish may provide a strong indication of the location of a given client device 140.

Moreover, in one embodiment, the usage pattern data may derive, at least in part, from data associated with the distribution of online transactions, such as online retail purchases, financial transactions and/or the like. Specifically, the magnitude of the amount of online transactions occurring within a given geographic area may vary significantly both in relation to the time of day (e.g., during business hours as opposed to at night) and the specific day of the week (e.g., weekdays vs. weekends). By analyzing the online transactions originating from users located within a given geographic area, a pattern(s) may be identified for the geographic area that potentially varies from other geographic areas, particularly geographic areas located in different time zones or that practice different business hours.

Further, in one embodiment, the usage pattern data may derive, at least in part, from data associated with the usage of specific time-related search entries. For instance, for certain terms and phrases, the likelihood that one of such terms or phrases is used within an online search entry or request at a given time may be significantly higher than the likelihood that such term or phrase is used at another time, which may allow for geographic areas to be distinguished based on differences in time zones or based on cultural differences or other area-specific factors. As an example, a higher volume of search requests including the term “breakfast” may be received during the hours of 7:00 AM to 10:00 AM than at any other time during the day whereas the volume of search requests including the term “dinner” or “supper” received during the hours of 5:00 PM to 9:00 PM may be higher than at any other time.

In addition, in one embodiment, the usage pattern data may derive, at least in part, from data associated with the distinctions in daily usage volume, such as distinctions in usage volumes on weekdays as opposed to weekends. For example, usage volumes of certain online activities (or all online activities as a whole) may vary from day-to-day, particularly comparing usage volumes on Monday-Friday versus usage volumes on Saturday and Sunday. This may be particularly true for geographic areas that have differing work weeks as opposed to other geographic areas. For example, many Muslim countries have work weeks that span Sunday to Thursday or Saturday to Wednesday. As a result, these countries may have very different daily usage volumes than other countries having a traditional work week spanning from Monday to Friday.

It should be appreciated that the above described usage pattern signals are simply provided as several examples of suitable signals from which the usage pattern data may be derived. However, in other embodiments, the usage pattern data may be derived from any other suitable online-based pattern signals. Moreover, it should be appreciated that a pattern signal may be used individually or in combination with other pattern signals when collecting usage pattern data.

Referring still to FIG. 2, at (204), the method 200 includes determining a usage pattern classifier for the geographic area based on the first set of usage pattern data. Specifically, as indicated above, the first set of usage pattern data may be input into a machine learning system or algorithm and used as training data in order to develop a unique classifier that characterizes the online usage patterns of users located within the specific geographic area. As will be described below, the classifier developed for each geographic area may then be used to assess the usage pattern data available from IP addresses that have been previously associated to the geographic area.

As (206), the method 200 includes accessing a second set of usage pattern data from one or more IP addresses contained within an IP block that has been mapped to the geographic area. Specifically, in addition to analyzing usage pattern data from IP addresses known to be assigned to client devices 140 located within the geographic area, the server 110 may be configured to analyzed usage pattern data from IP addresses that have been previously mapped to the geographic area, regardless of whether the locations of the client devices 140 associated with such IP addresses have been confirmed or are otherwise known. In doing so, it may be desirable for the second set of usage pattern data accessed by the server 110 to be of the same type of usage pattern data included within the first set of data. For example, if the first set of usage pattern data derives from a combination of specific pattern signals (e.g., a combination of usage cycles of online applications and the language distribution contained within online text entries), it may be desirable to derive the second set of usage pattern data from the same combination of pattern signals or a subset thereof

It should be appreciated that all or a portion of the data contained within the second set of usage pattern data may also be included within the first set of usage pattern data. For instance, the first set of usage pattern data may derive, at least in part, from IP addresses included within a plurality of different IP blocks that have been mapped to a given geographic area. Thereafter, the second set of usage pattern data may, for example, correspond to the individual usage pattern data associated with just one of the IP blocks that had been mapped to the geographic area.

Additionally, as shown in FIG. 2, at (208), the method 200 includes analyzing the second set of usage pattern data based on the usage pattern classifier associated with the geographic area. Specifically, as indicated above, the second set of usage pattern data may be input into the classifier in order to assess the accuracy of the mapping of the IP addresses contained within the IP block to the specific geographic area. For example, by inputting the second set of usage pattern data into the classifier, a confidence score may be obtained that indicates how well the data matches the initial data collected from IP addresses known to be associated with the geographic area, thereby providing a direct indication of the accuracy of the IP block's mapping to such area. In particular, in several embodiments, the confidence score may be compared to a predetermined threshold selected for IP block mappings. In such embodiments, if the confidence score exceeds the predetermined threshold, it may be determined that the IP block was properly mapped to the geographic area. However, if the confidence score falls below the predetermined threshold, the IP block mapping may be identified as having some level of inaccuracies or may simply be flagged as needing further analysis to assess its accuracy.

In several embodiments, when the confidence score associated with the mapping of a given IP block to a specific geographic area is less than the predetermined threshold, the usage pattern data for the IP block may be input into the usage pattern classifier developed for one or more other geographic areas to determine whether the usage pattern data more closely matches the data for such other area(s). For example, in one embodiment, the usage pattern data for the IP block may be input into every other usage pattern classifier that has been developed to determine which classifier provides the highest confidence score. In such instance, the geographic area associated with the classifier providing the highest confidence score may be identified as the best match for the IP addresses associated with the IP block. Alternatively, the resulting confidence scores may simply be used to identify a small set of geographic areas that are more likely than others to be associated with the IP block.

As indicated above, the present subject matter is also directed to a method for identifying a candidate geographic area(s) for an IP block that has not been previously mapped or otherwise assigned to a specific geographic area. In doing so, the server 110 may be configured to analyze the usage pattern data associated with the IP block in light of the usage pattern classifiers developed for a plurality of different geographic areas. For example, by inputting the IP block's data into each classifier, a confidence score may be generated for each associated geographic area. Thereafter, the server 110 may be configured to identify a candidate geographic area(s) for mapping the IP block based on the confidence scores, such as by selecting the geographic area having the highest confidence score or by selecting a small set of geographic areas having relatively high confidence scores.

While the present subject matter has been described in detail with respect to specific exemplary embodiments and methods thereof, it will be appreciated that those skilled in the art, upon attaining an understanding of the foregoing may readily produce alterations to, variations of and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for assessing the accuracy of Internet Protocol (IP) address-based geolocation data, the method comprising:
accessing, by one or more computing devices, a first set of usage pattern data associated with a plurality of IP addresses that are known to be assigned to computing devices located within a geographic area, the first set of usage pattern data associated with online-based activities;
determining, by the one or more computing devices, a usage pattern classifier for the geographic area based on the first set of usage pattern data;
accessing, by the one or more computing devices, a second set of usage pattern data associated with at least one IP address contained within an IP block that has been mapped to the geographic area, the second set of usage pattern data associated with online-based activities; and
analyzing, by the one or more computing devices, the second set of usage pattern data based on the usage pattern classifier in order to assess the accuracy of the mapping of the IP block to the geographic area.

2. The computer-implemented method of claim 1, wherein analyzing the second set of usage pattern data comprises inputting the second set of usage pattern data into the usage pattern classifier to generate a confidence score associated with the mapping of the IP block to the geographic area, wherein the confidence score is associated with an accuracy of the mapping of the IP block to the geographic area.

3. The computer-implemented method of claim 2, further comprising:
comparing the confidence score to a predetermined threshold selected for IP block mappings; and
if the confidence score is less than the predetermined threshold, identifying the mapping of the IP block to the geographic area as a mapping that contains inaccuracies.

4. The computer-implemented method of claim 2, further comprising:
comparing the confidence score to a predetermined threshold selected for IP block mappings; and
if the confidence score is less than the predetermined threshold, analyzing the second set of usage pattern data based on a usage pattern classifier developed for a second geographic area in order to assess whether the IP block should be mapped to the second geographic area.

5. The computer-implemented method of claim 1, wherein determining the usage pattern classifier comprises inputting the first set of usage pattern data into a machine learning algorithm in order to develop the usage pattern classifier.

6. The computer-implemented method of claim 1, wherein the first and second sets of usage pattern data include data associated with a usage cycle for at least one online-based application.

7. The computer-implemented method of claim 1, wherein the first and second sets of usage pattern data include data associated with a language distribution of text entered when performing the online-based activities.

8. The computer-implemented method of claim 1, wherein the first and second sets of usage pattern data include data associated with a distribution of online transactions.

9. The computer-implemented method of claim 1, wherein the first and second sets of usage pattern data include data associated with a usage of time-related search terms.

10. The computer-implemented method of claim 1, wherein the first and second sets of usage pattern data include data associated with at a daily online usage pattern.

11. The computer-implemented method of claim 1, wherein the geographic area comprises one of a country, a state or a city.

12. A system for assessing the accuracy of Internet Protocol (IP) address-based geolocation data, the system comprising:
one or more computing devices including one or more processors and associated memory, the memory storing instructions that, when executed by the one or more processors, configure the one or more computing devices to:
access a first set of usage pattern data associated with a plurality of IP addresses associated within a geographic area, the first set of usage pattern data associated with online-based activities;
determine a usage pattern classifier for the geographic area based on the first set of usage pattern data;
access a second set of usage pattern data associated with at least one IP address that has been mapped to the geographic area, the second set of usage pattern data associated with online-based activities; and
analyze the second set of usage pattern data based on the usage pattern classifier in order to assess the accuracy of the mapping of the at least one IP address to the geographic area.

13. The system of claim 12, wherein the one or more computing devices are configured to analyze the second set of usage pattern data by inputting the second set of usage pattern data into the usage pattern classifier to generate a confidence score associated with the mapping of the IP block to the geographic area.

14. The system of claim 13, wherein the one or more computing devices are further configured to compare the confidence score to a predetermined threshold selected for IP address mappings and, if the confidence score is less than the predetermined threshold, identity the mapping of the at least one IP address to the geographic area as a mapping that contains inaccuracies.

15. The system of claim 13, wherein the one or more computing devices are further configured to compare the confidence score to a predetermined threshold selected for IP address mappings and, if the confidence score is less than the predetermined threshold, analyze the second set of usage pattern data based on a usage pattern classifier developed for a second geographic area in order to assess whether the at least one IP address should be mapped to the second geographic area.

16. The system of claim 12, wherein the first and second sets of usage pattern data include data associated with at least one of a usage cycle for at least one online-based application, a language distribution of text entered when performing the online-based activities, a distribution of online transactions, a usage of time-related search terms or a daily online usage pattern.

17. The system of claim 12, wherein the geographic area comprises one of a country, a state or a city.

18. A tangible, non-transitory computer-readable medium storing computer-executable instructions that, when executed by one or more processors, cause the one or more processors to perform operations, comprising:
accessing a usage pattern classifier for each of a plurality of different geographic areas, each usage pattern classifier being based on usage pattern data derived from a plurality of IP addresses that are known to be assigned to computing devices located within one of the geographic areas;
accessing a second set of usage pattern data associated with at least one IP address contained within an IP block;
inputting the second set of usage pattern data into the usage pattern classifier for each geographic area to generate a confidence score associated with the geographic area; and
identifying at least one candidate geographic area out of the plurality of different geographic areas for mapping the IP block based on the confidence score.

19. The computer readable medium of claim 18, wherein identifying the at least one candidate geographic area comprises identifying the geographic area associated with the highest confidence score.

20. The computer readable medium of claim 18, wherein identifying the at least one candidate geographic area comprises identifying the geographic areas associated with confidence scores that exceed a predetermined threshold.
